(19) United States
(12) Patent Application Publication
(10) Pub. No.: US 2024/0191834 A1
(43) Pub. Date: Jun. 13, 2024

(54) PORTABLE AND VARIABLE DIRECTIONAL MOUNTING DEVICE, METHOD AND SYSTEM

(71) Applicant: Constantinos Hatzopoulos, Los Angeles, CA (US)

(72) Inventor: Constantinos Hatzopoulos, Los Angeles, CA (US)

(21) Appl. No.: 18/065,277

(22) Filed: Dec. 13, 2022

(51) Int. Cl. F16M 13/02; F16B 2/08

(52) U.S. Cl. CPC F16M 13/022; F16B 2/08

(57) ABSTRACT

Devices, systems and methods of mounting objects upon various surfaces are disclosed. These surfaces can be regular or irregular such as surfaces with gaps. Some exemplary embodiments of the irregular surfaces can be iron rod fencing, scaffolding, pipes, rails, handrails, grates, metal grates, metal bars, and similar surfaces. The disclosure provides the necessary leverage and surfaces to receive insertion that is necessitated by the process of mounting an object at a surface in a secure and leveraged manner.

### TECHNICAL FIELD

The present disclosure relates to the field of construction. Specifically, the present invention relates to a portable variable directional mounting device, a portable and variable directional mounting system and methods of using a portable and variable directional mounting device or system.

### BACKGROUND

Mounting or fixing an object to a specific location or area such as a wall is a common need amongst all types of consumers and industries. The need or desire to mount something can arise for personal needs such as decorating. The need or desire to mount something can arise for message purposes such as informational signage.

Prior techniques and devices used in such scenarios fail for various reasons such as consisting of insubstantial and vulnerable materials, methods of use that are susceptible to issues during regular mechanical and physical occurrences, and/or the devices themselves have limited capabilities due to their design. This invention resolves the issue that often situations call for mounting objects wherein the subordinate layer is an irregular or incomplete plane. For example, but not limited to, scaffolding on the side of a building or signage on an iron fencing. The present invention is a novel and innovative manner of allowing attachment to such surfaces or planes in a plurality of positions. This innovative manner will incorporate wrapping and thereby attaching a mounting mechanism with the irregular surface that is then attached to the object intended to be mounted or related component.

### SUMMARY

Aspects and advantages of the invention will be set forth in part in the following description, or may be obvious from the description, or may be learned through practice of the invention.

In general, one innovative aspect of the subject matter described in this specification can be embodied as a device wherein the device includes a channel, an actuator, and a fastener.

In some embodiments, the device includes a channel, an actuator, a fastener, wherein the channel of the device traverses the centroid of the actuator.

In some embodiments, the device includes a channel, an actuator, a fastener, wherein the actuator has a mounting surface.

In some embodiments, the device includes a channel, an actuator, a fastener, wherein the actuator has a mounting surface and the plane of the mounting surface is parallel to the direction of the traversing path of the channel.

In some embodiments, the device includes a channel, an actuator, a fastener, wherein the actuator has a mounting surface and wherein the mounting surface is configured to accept a pinning mechanism.

In some embodiments, the device includes a channel, an actuator, a fastener, wherein the actuator has a mounting surface and wherein the mounting surface is configured to accept a pinning mechanism further wherein the pinning mechanism enters a second mounting surface after traversing the mounting surface of the actuator.

In some embodiments, the device includes a channel, an actuator, a fastener, wherein the actuator has a mounting surface and wherein the mounting surface is configured to accept a pinning mechanism wherein the mounting surface is configured with a screw hole.

In some embodiments, the device includes a channel, an actuator, a fastener, wherein the actuator has a mounting surface and wherein the mounting surface is configured to accept a pinning mechanism wherein the mounting surface is configured with a screw hole, wherein the pinning mechanism is a screw.

In some embodiments, the device includes a channel, an actuator, a fastener, wherein the fastener is a thin, flexible strap with a notched surface

In some embodiments, the device includes a channel, an actuator, a fastener, wherein the fastener is a thin, flexible strap with a notched surface and the strap is threaded through a locking mechanism attached to one end of the strap itself.

In some embodiments, the device includes an actuator, a fastener and multiple channels.

In some embodiments, the device includes an actuator, a fastener and multiple channels, wherein the multiple channels traverse in different directions.

In some embodiments, the device includes an actuator, a fastener and multiple channels, wherein all the multiple channels traverse in the same general direction.

In some embodiments, the device includes an actuator, multiple fasteners and multiple channels.

In some embodiments, the number of pinning mechanisms exceeds the number of channels and fasteners.

The disclosure also demonstrates multiple inventive methods. This includes, but is not limited to, a method of mounting on a surface, comprising of the steps of providing a device comprising of a channel, an actuator, a mounting surface, a fastener, wherein the channel traversing the centroid of the actuator, disposing the actuator near the irregular surface to be mounted, disposing the fastener in a manner wherein the fastener traverses the channel and then fastening the fastener.

In some embodiments, the method of mounting on a surface includes the steps of providing a device comprising of a channel, an actuator, a mounting surface, a fastener, wherein the channel traversing the centroid of the actuator, disposing the actuator near the irregular surface to be mounted, disposing the fastener in a manner wherein the fastener traverses the channel and then fastening the fastener further wherein a pinning mechanism is provided and traverses the object to be mounted and enters the device.

In some embodiments, the method of mounting on a surface includes the steps of providing a device comprising of a channel, an actuator, a mounting surface, and a fastener, wherein the channel traversing the centroid of the actuator, disposing the actuator near the irregular surface to be mounted, disposing the fastener in a manner wherein the fastener traverses the channel and then fastening the fastener, further wherein a pinning mechanism is provided and traverses the object to be mounted and enters the device and further wherein the pinning mechanism enters at the mounting surface of the device.

In some embodiments, the method of mounting on a surface includes the steps of providing a device comprising of a channel, an actuator, a mounting surface, a fastener, wherein the channel traversing the centroid of the actuator, disposing the actuator near the irregular surface to be mounted, disposing the fastener in a manner wherein the fastener traverses the channel and then fastening the fastener further wherein a pinning mechanism is provided and traverses the object to be mounted and enters the device, further wherein the pinning mechanism is a screw.

In some embodiments, the method of mounting on a surface, comprising of the steps of providing a device comprising of a channel, an actuator, a mounting surface, a fastener, wherein the channel traversing the centroid of the actuator, disposing the actuator near the irregular surface to be mounted, disposing the fastener in a manner wherein the fastener traverses the channel and then fastening the fastener, further wherein multiple pinning mechanisms are provided and at least some of the pinning mechanisms traverse the object to be mounted and enter the device.

In some embodiments, the method of mounting on a surface, comprising of the steps of providing a device comprising of a channel, an actuator, a mounting surface, a fastener, wherein the channel traversing the centroid of the actuator, disposing the actuator near the irregular surface to be mounted, disposing the fastener in a manner wherein the fastener traverses the channel and then fastening the fastener, further wherein multiple pinning mechanisms are provided and the pinning mechanisms traverse the object to be mounted and enter the device.

In some embodiments, the method of mounting on a surface, comprising of the steps of providing a device comprising of a channel, an actuator, a mounting surface, a fastener, wherein the channel traversing the centroid of the actuator, disposing the actuator near the irregular surface to be mounted, disposing the fastener in a manner wherein the fastener traverses the channel and then fastening the fastener, further a pinning mechanism is provided and the pinning mechanism is also the object to be mounted on the irregular surface.

In some embodiments, the method of mounting on a surface, comprising of the steps of providing a device comprising of a channel, an actuator, a mounting surface, a fastener, wherein the channel traversing the centroid of the actuator, disposing the actuator near the irregular surface to be mounted, disposing the fastener in a manner wherein the fastener traverses the channel and then fastening the fastener, wherein multiple pinning mechanisms are provided and the pinning mechanisms traverse the object to be mounted and enter the device, and further wherein the pinning mechanism enters the device at the mounting surface of the device.

The disclosure also includes a system includes an actuator, at least one fastener and at least one pinning mechanism, wherein the actuator further comprises a channel, wherein the channel traversing the centroid of the actuator.

In some embodiments, the system includes an actuator, at least one fastener and at least one pinning mechanism, wherein the actuator further comprises of a channel, wherein the channel traversing the centroid of the actuator, and wherein the actuator further comprises a mounting surface.

In some embodiments, the system includes an actuator, at least one fastener and at least one pinning mechanism, wherein the actuator further comprises of a channel, wherein the channel traversing the centroid of the actuator, and wherein the pinning mechanisms are screws.

### BRIEF DESCRIPTION OF THE FIGURES

A full and enabling disclosure of the present invention, including the best mode thereof, directed to one of ordinary skill in the art, is set forth in the specification, which makes reference to the appended drawings in, which:

FIG. 1 is a top, front, left perspective view of an embodiment of the device 10 with one channel 15, one fastener 25, one pinning mechanism 50, one mounting surface 35, an actuator 20 wherein the general location of the centroid 30 is shown and further wherein the device 10 is mounted to a fence post;

FIG. 2 is a top, front, left perspective view of an embodiment of the device 10 with one channel 15, one fastener 25, two pinning mechanisms 50, one mounting surface 35, an actuator 20 and further wherein the device 10 is mounted to a fence post;

FIG. 3 is a top, front, left perspective view of an embodiment of the device 10 with two channels 15, two fasteners 25, two pinning mechanisms 50, one mounting surface 35, an actuator 20 and further wherein the device 10 is mounted to a fence post;

FIG. 4 is a top, front, left perspective view of an embodiment of the device 10 with two channels 15, two fasteners 25, one pinning mechanism 50, an actuator 20 and further wherein the device 10 is mounted to a fence post in a vertical manner;

FIG. 5 is a top, front, left perspective view of an embodiment of the device 10 with one channel 15, one fastener 25, one pinning mechanism 50, one mounting surface 35, an actuator 20 and further wherein the device 10 is mounted to a fence post; and the pinning mechanism 50 is the object to be mounted;

FIG. 6 is a top, front, left perspective view of an embodiment wherein two devices 10 are used together and the pinning mechanisms 50 insert through the object to be mounted and into the mounting service 35 of the device;

FIG. 7 is a top, front, left perspective view of an embodiment of the device 10 with two channels 15, two fasteners 25, one pinning mechanism 50, an actuator 20 and further wherein the device 10 is mounted to a fence post in a vertical manner and the pinning mechanism 50 is a hook;

FIG. 8 is a front, right perspective view of an embodiment of the device 10 with three channels 15, three fasteners 25, one pinning mechanism 50, and one mounting service 35 wherein the plane of the mounting service is perpendicular to the path of the channel 15;

FIG. 9 is a top, front, right perspective view of an embodiment wherein the device 10 has multiple mounting services 35;

FIG. 10 is a top, front, left perspective view of an embodiment of the device 10 having four pinning mechanisms 50 and wherein the device 10 is mounted to an arcing object;

Repeat use of reference characters in the present specification and drawings is intended to represent the same or analogous features or elements of the present invention.

### DETAILED DESCRIPTION

Reference now will be made in detail to the embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a further embodiment. Thus, it is intended that the present invention covers such modifications and variations as come within the scope of the appended claims and their equivalents.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

In accordance with the present invention, a disclosure is made of a device, method and system that assists with mounting on regular, irregular and unsupported surfaces. In exemplary embodiments the invention is shown as a device 10 that assists with mounting on regular, irregular and unsupported surfaces. The device 10 includes a channel 15, an actuator 20, a fastener 25, wherein the channel 15 traverses the centroid 30 of the actuator 20. The channel 15 generally traverses the centroid 30 of the actuator 20. The actuator 20 actuates the mounting by providing a leverage point for the fastener 25, the channel 15, the device 10 as a whole and the object to be mounted and/or interconnected or objects. The actuator 20 may also provide a mounting surface 35.

Within this specification and application as a whole the channel 15 is a cavity of space within the actuator 20 such as a tunnel or passageway that thereby enables passage or traversing of the fastener 25 within the actuator 20. Within this specification and application as a whole the centroid 30 is the approximate geometric center of the object being referenced or described. Within this specification and application as a whole the actuator 20 is the component or device that enables the leveraging support for the device 10 when utilized in connection with the one or more fasteners 25. Within this specification and application as a whole the fastener 25 is a component or device that closes or secures something. Within this specification and application as a whole the pinning mechanism 50 is a component or device that holds an object or objects firmly in a specified position.

The channel 15 is designed to sufficiently traverse the actuator 20 so that upon fastening the fastener 25 the actuator 20 is secured in position and able to provide leverage to other components or devices. In many embodiments the actuator 20 is shaped as a rectangular prism, cube, and similar 6 sided shapes. In some embodiments the actuator 20 is shaped as a sphere or similar geometric shapes. In some embodiments the device 10 can utilize more than one fastener 25. The fastener 25 can be in many forms. The fastener 25 can be string, rope, fishing line and similar fastening objects. The fastener 25 can be wherein the fastener 25 is a thin, flexible strap with a notched surface, wherein the strap is threaded through a locking mechanism 28 attached to one of the two ends of the strap. The fastener 25 can be wherein the fastener 25 is a thin, flexible nylon strap with a notched surface, wherein the nylon strap is threaded through a locking mechanism attached to one of the two ends of the nylon strap (also commonly identified as a zip-tie). In some embodiments the fastener 25 is a two or multicomponent device, wherein the components that traverse the channel 15 and the components that lock are separate. In some embodiments more than one fastener 25 is utilized with an actuator 20.

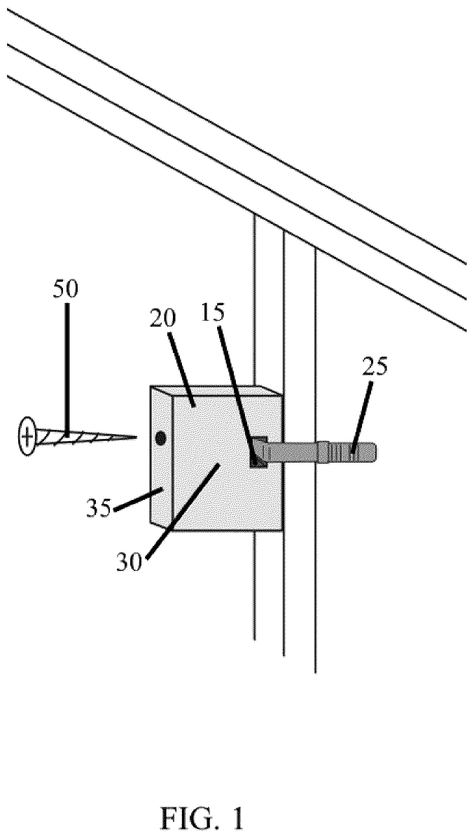

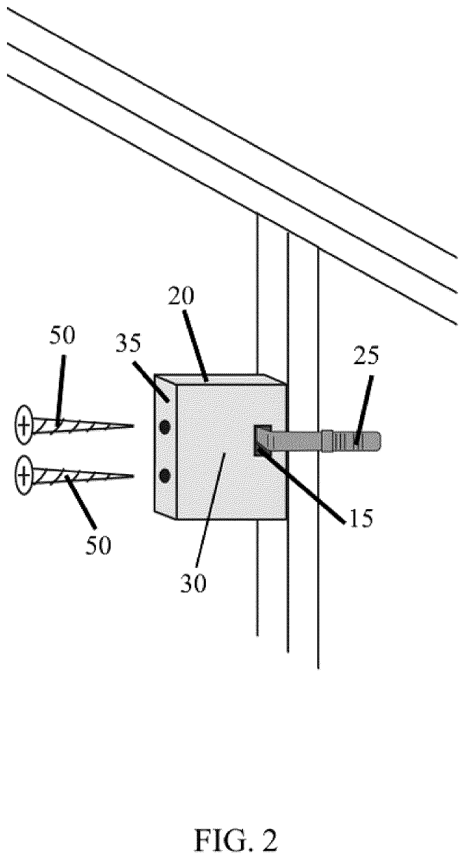

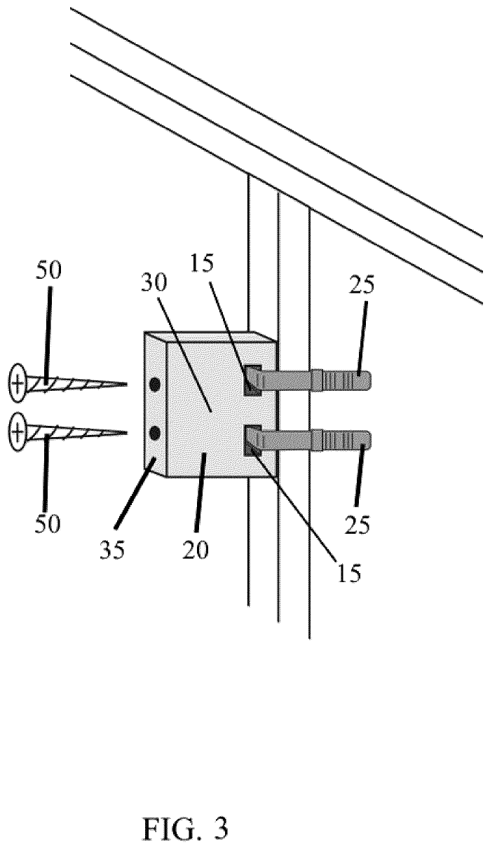

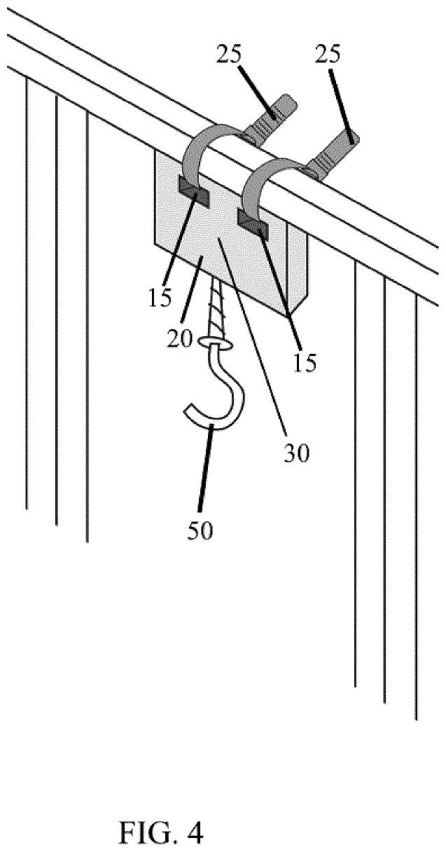

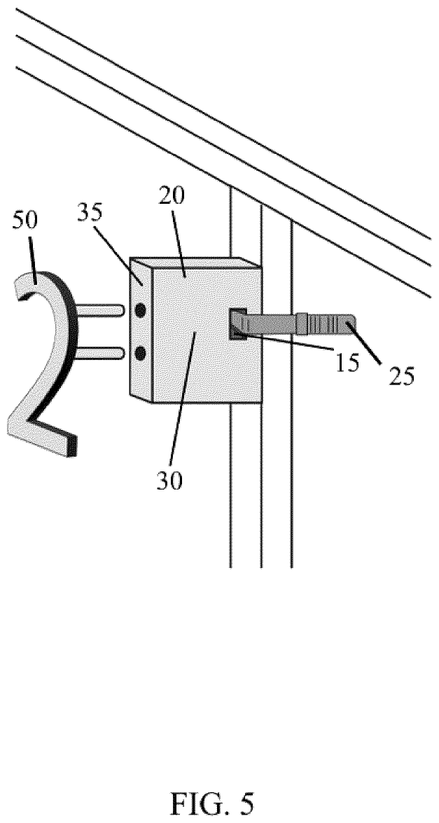

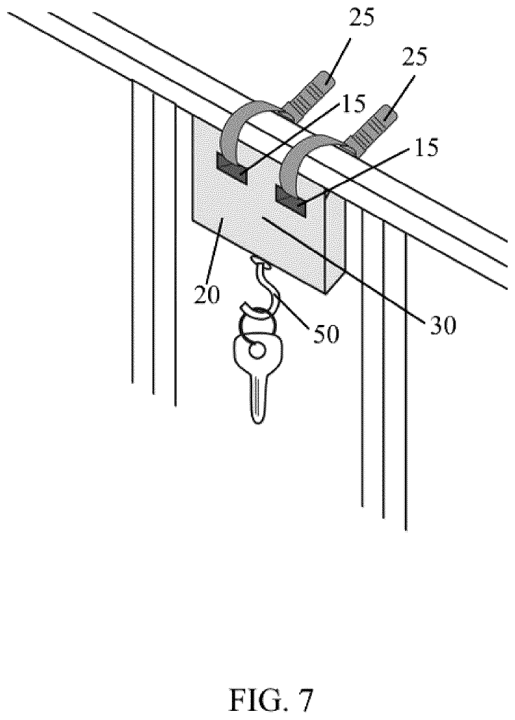

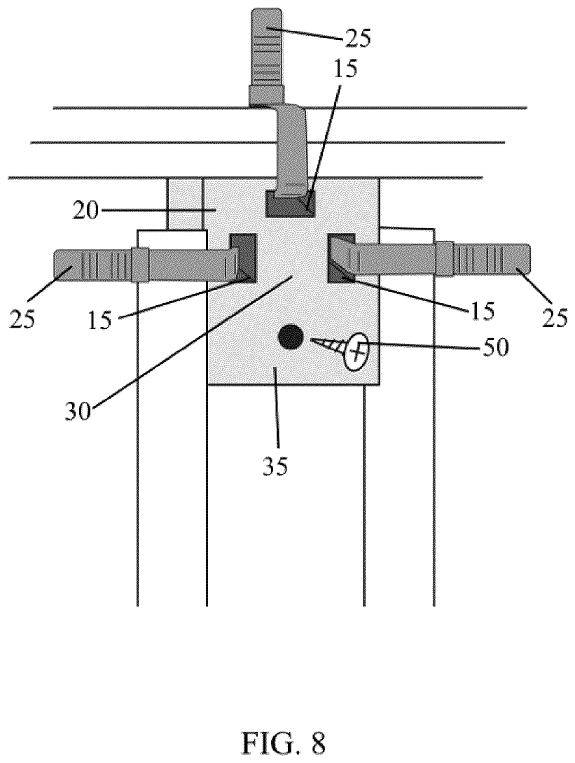

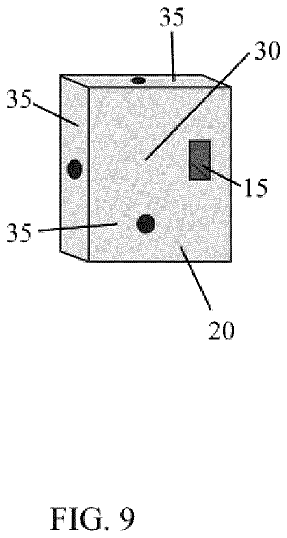

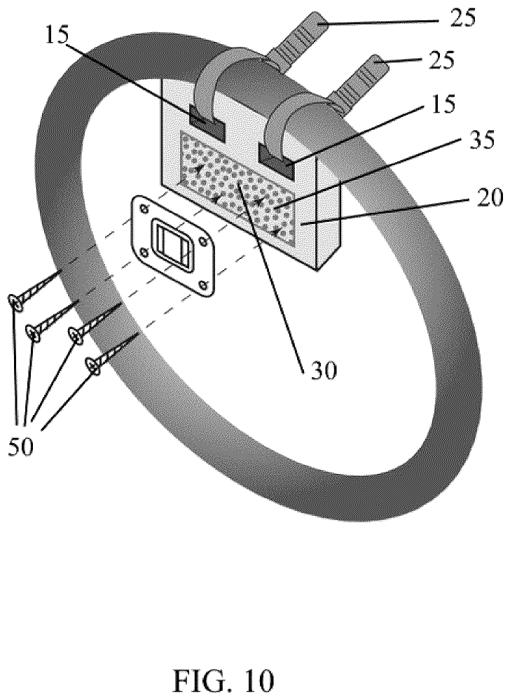

As shown in FIGS. 1-7, in some embodiments the channel 15 is designed to have a traversing direction that is to be parallel to the plane of the mounting surface 35, wherein if the plane of the mounting surface 35 and the plane of the traversing direction were extended any distance, they would maintain a constant distance from each other. As shown in FIGS. 8 and 10, in some embodiments the channel 15 is designed to have a traversing direction that is to be perpendicular to the plane of the mounting surface 35. As shown in FIG. 9 the mounting surface 35 may be parallel with the traversing directions of some channels 15 and perpendicular to the traversing direction of the other channels 15.

The mounting surface 35 can be in many different embodiments. The mounting surface 35 may be indistinguishable from other surfaces of the actuator 20. The mounting surface 35 may have clear distinguishing markings. In exemplary embodiments the mounting surface 35 is a raised surface. The mounting surface 35 may be designed to accept a pinning mechanism 50 in many manners. The mounting surface 35 may be configured with markings identifying where to insert the pinning mechanism 50. The mounting surface 35 may be configured with markings identifying where not to insert the pinning mechanism 50. The mounting surface 35 may be configured with markings identifying where to insert, and where not to insert, the pinning mechanism 50. The mounting surface 35 may be configured with a hole corresponding to the shape of the pinning mechanism 50. The mounting surface 35 may be configured with a hole corresponding to the shape of a portion or component of the pinning mechanism 50. The mounting surface 35 may be configured with a complete or partial screw hole designed to accept a standard screw. The pinning mechanism 50 can be in many forms such as a pin, screw, nail, or similar mechanisms. The pinning mechanism 50 may be embodied to have a sufficient length to traverse the actuator 20 completely. Further, the pinning mechanism 50 may be embodied to have a sufficient length to traverse the actuator 20 completely and enter a second mounting surface 35. This second mounting surface 35 may be part of the device. In some embodiments the second mounting surface 35 is not part of the device 10. When the device includes a pinning mechanism 50, in some embodiments the pinning mechanism 50 is also the object to be mounted.

The device 10 and the number of components can come in a plurality of embodiments. The device 10 can include multiple channels 15. In some embodiments the device 10 can include multiple fasteners 25. In some embodiments the device 10 can include multiple channels 15 and multiple fasteners 25. In some embodiments the device 10 can include multiple pinning mechanisms 50. In some embodiments the device 10 can include multiple channels 15 and multiple pinning mechanisms 50. In some embodiments the device 10 can include multiple pinning mechanisms 50 and multiple fasteners 25. In some embodiments the device 10 can include multiple channels 15, multiple pinning mechanisms 50, and multiple fasteners 25. The device 10 may have a greater number of pinning mechanisms 50 than the number of channels 15. The device 10 may have a greater number of pinning mechanisms 50 than the number of fasteners 25. In some embodiments the number of pinning mechanisms 50 is greater than both the number of channels 15 and the number of fasteners 25. In some embodiments the ratio of fasteners 25 to channels 15 may exceed one to one. For example there might be two, three, four or more fasteners 25 per channel 15.

In embodiments of the device having multiple channels 15, the direct the channels traverse can be in a plurality of orientations. In some embodiments, all the channels 15 traverse in the same exact direction. In some embodiments, all the channels 15 traverse in the different directions. In some embodiments, all the channels 15 traverse in the same general direction

The present disclosure also discloses several embodiments of methods of mounting objects. In some embodiments the surface or space the object is to be mounted at or near is irregular, hereinafter referred to as an irregular surface. For example, the object may be intended to be mounted to iron grates, scaffolding, pipes, railings, or planks. In some embodiments the irregular surface can be described as a surface with gaps, such as the front of an iron fence. The disclosure includes a method of placing the device 10 at, near, or adjacent to the area of interest wherein the mounting is desired. This placement will also by consequence result in the actuator 20 being disposed or placed at, near or adjacent to the area the mounting is desired.

After placement then the fastener 25 disposed, positioned, or moved to traverse the channel 15 of the actuator 20 and then fasten the fastener 25. Upon fastening the actuator 20 is provided leverage or support and can provide leverage to other objects, such as an object to be mounted. The fastening of the fastener 25 utilizes tension force with the actuator 20 by traversing the channel 15. In some embodiments more than one fastener 25 is utilized with an actuator 20. The embodiments of the components of the device 10 described above can be utilized in the method embodiments of this disclosure.

After the fastener 25 are fastened, pinning mechanisms 50 in conjunction with the actuator 20 may be used to mount an object. The pinning mechanism 50 as described above may enter a specific surface of the actuator 20, identified as the mounting surface 35. In some embodiments the pinning mechanism 50 may be positioned to first enter and traverse the object that is to be mounted and then continue into the mounting surface 35. In further embodiments the pinning mechanism 50 may further traverse completely through the actuator 20 and enter an object that the fastener 25 is fastened around. In some embodiments the pinning mechanisms 50 may be positioned to first enter the actuator 20 and then an object that the fastener 25 is fastened around. In some embodiments the pinning mechanisms 50 may be positioned to first enter the mounting surface 35 of the actuator 20 and then an object that the fastener 25 is fastened around. In some embodiments more than one pinning mechanism 50 is utilized with the actuator 20.

The present invention, previously described as a device and method, can be incorporated into a system wherein the device 10 is the entire system or a part of a larger system. The present disclosure can be embodied as a system wherein the device 10 and the at least one fastener 25 are the components of the system. The present disclosure may be described as a system wherein the actuator 20 and the at least one fastener 25 are the components of the system. In some embodiments the system may have additional components. In some embodiments the system will include a pinning mechanism 50. In some embodiments, the pinning mechanism 50 may be a screw. The pinning mechanism 50 as described above may enter a specific surface of the actuator, identified as the mounting surface 35. In some embodiments the pinning mechanism 50 may be positioned to first enter and traverse the object that is to be mounted and then continue into the mounting surface 35. In further embodiments the pinning mechanism 50 may further traverse completely through the actuator 20 and enter an object that the fastener 25 is fastened around. In some embodiments the pinning mechanisms 50 may be positioned to first enter the actuator 20 and then an object that the fastener 25 is fastened around. In some embodiments the pinning mechanisms 50 may be positioned to first enter the mounting surface 35 of the actuator 20 and then an object that the fastener 25 is fastened around. In some embodiments the pinning mechanism 50 is the object to be mounted.

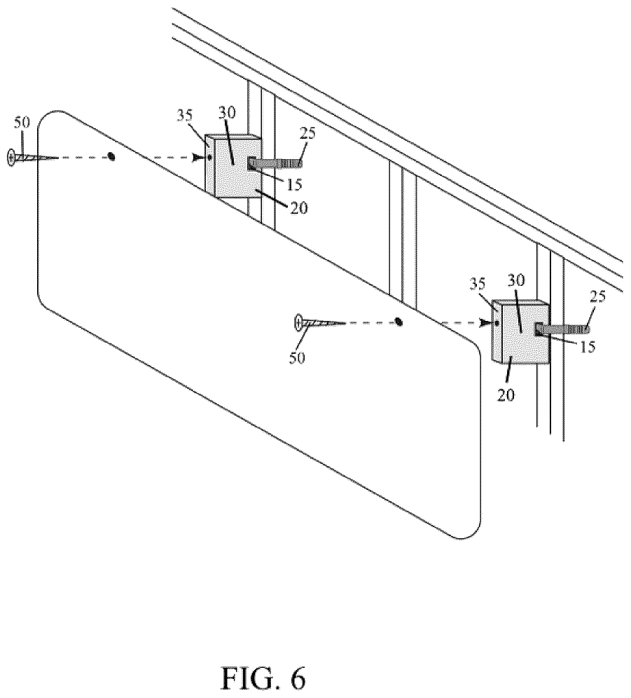

As shown in FIG. 6 it is possible that the system may have two devices 10 and two actuators 20. Furthermore, and as shown in FIG. 6, these two actuators can work together in mounting the same object.

All elements of all embodiments, as previously specified and/or unspecified, of the present invention are easily and capably produced through various manufacturing techniques. All elements of all embodiments, as previously specified and/or unspecified, of the present invention can be manufactured at various lengths, widths, heights, thicknesses, weights, designs, shapes, sizes, colors, and other various features and characteristics. The present invention can be manufactured from various types of materials and compositions, including various metals and/or metal alloys, various plastics and/or plastic compositions, various woods, and/or other various organic and/or inorganic compounds and materials. However, the present invention may also utilize various types of materials, components, methods, designs, and patterns to achieve the desired result and function.

The invention can be applied in other industries as well. The invention has specific and effective applications in the industries of residential building, residential decoration, and film production.

What is claimed is:

1. A device comprising of a channel, an actuator, and a fastener.

2. The device of claim 1, wherein the channel traverses the centroid of the actuator.

3. The device of claim 1, wherein the actuator has a mounting surface.

4. The device of claim 3, wherein the plane of the mounting surface is parallel to the direction of the traversing path of the channel.

5. The device of claim 3, wherein the mounting surface is configured to accept a pinning mechanism.

6. The device of claim 5, wherein the mounting surface is configured with a screw hole and the pinning mechanism is a screw.

7. The device of claim 1, wherein the fastener is a thin, flexible strap with a notched surface and a locking mechanism attached to one of the two ends of the strap

8. A method of mounting on a surface, comprising of the steps of:
providing a device comprising of a channel, an actuator, a mounting surface, a fastener, wherein the channel traversing the centroid of the actuator;
disposing the actuator near the irregular surface to be mounted;
disposing the fastener in a manner wherein the fastener traverses the channel and then fastening the fastener.

9. The method of claim 8, wherein a pinning mechanism is provided and traverses the object to be mounted and enters the device.

10. The method of claim 9, wherein the pinning mechanism enters at the mounting surface of the device.

11. The method of claim 10, wherein multiple pinning mechanisms are provided and the pinning mechanisms traverse the object to be mounted and enter the device.

12. The method of claim 10, wherein the pinning mechanism and the object to be are the same.

13. A system comprising an actuator, at least one mounting surface, at least one fastener and at least one pinning mechanism, wherein the actuator further comprises a channel, wherein the channel traversing the centroid of the actuator.

14. The system of claim 13, wherein the pinning mechanism is a screw.

15. The device of claim 5, wherein the pinning mechanism enters a second mounting surface after traversing the mounting surface of the actuator.

16. The device of claim 1, further comprising multiple channels.

17. The device of claim 16, wherein the multiple channels all traverse the same general direction.

18. The device of claim 16, wherein the multiple channels traverse in multiple directions.

19. The device of claim 5, wherein the number of pinning mechanisms exceed the number of channels and fasteners.

20. The device of claim 19, further comprising of two fasteners being disposed in each channel.
